(19) United States
(12) Patent Application Publication
(10) Pub. No.: US 2016/0223472 A1
(43) Pub. Date: Aug. 4, 2016

(54) METHOD AND APPARATUS FOR CALIBRATION OF A MATERIAL CHARACTERIZATION SYSTEM

(71) Applicant: PaneraTech, Inc., Chantilly, VA (US)

(72) Inventors: Yakup Bayram, Falls Church, VA (US); Tom Sebastian, Fairfax City, VA (US); Joseph Molinaro, Arlington, VA (US)

(21) Appl. No.: 14/983,659

(22) Filed: Dec. 30, 2015

Related U.S. Application Data
(60) Provisional application No. 62/097,898, filed on Dec. 30, 2014.

(51) Int. Cl. G01N 22/00

(52) U.S. Cl. CPC G01N 22/00

(57) ABSTRACT

Disclosed is an improved method and apparatus to calibrate a material characterization system. The method and apparatus are operative to set up multiple configurations for measuring and recording a specific characteristic response of the system for each configuration, using electromagnetic waves. The apparatus is designed to enable the system to measure and record the position of a reference material and a set of calibration data for such reference material, while positioned at locations that correspond to a range of possible thicknesses or fluttering during measurements of a sample that the system is capable of characterizing. As a result, a sample under test having a specific thickness and measured at a particular position can be readily calibrated analytically or by using reference data previously recorded with the same set up.

### CROSS REFERENCE TO RELATED APPLICATIONS

This application is based upon and claims priority from co-pending U.S. Provisional Patent Application Ser. No. 62/097,898 entitled “Method and Apparatus for Calibration of a Material Characterization System” filed with the U.S. Patent and Trademark Office on Dec. 30, 2014, by the inventors herein, the specification of which is incorporated herein by reference.

### GOVERNMENT LICENSE RIGHTS

This invention was made with Government support under contract number SB1341-13-CN-0035, awarded by National Institute of Standards and Technology (NIST). The Government may have certain rights in the invention.

### FIELD OF THE INVENTION

The present invention relates generally to systems and methods for evaluating a material through measurements of transmitted energy. More particularly, the present invention relates to systems and methods for calibration of a material characterization system that is based on measured electromagnetic waves.

### BACKGROUND

Evaluation methods and apparatuses exist within various industries for characterizing electrical and physical properties of a material. Certain properties of a material may be determined by measuring the response of the material to electromagnetic waves impinging upon it, in terms of transmissivity, reflectivity, and absorptivity. In general, the characterization of a sample layer of material is based on a measurement of the electromagnetic scattering parameters of such layer as compared to the corresponding set of electromagnetic scattering parameters, using the same set up, of a layer of reference material used for calibration. Thus, two sets of measurements are performed requiring a set up as identical as possible to avoid characterization inaccuracies.

Accordingly, the performance and reliability of a material characterization system depends on the accuracy and repeatability of a set of measurements conducted to calibrate such system. In particular, the characterization of single-layer and multilayer materials by means of electromagnetic waves heavily relies on an accurate calibration of the scattering parameters of the system.

More specifically, a universal calibration method and apparatus to determine a characteristic of certain materials by means of radio frequency sensors have been addressed in the prior art, as described in U.S. Pat. No. 6,691,563 to Trabelsi et al. However, this method is primarily aimed to determine a universal calibration equation exclusively for estimating the level of moisture content of a material at a given time, based on experimental data.

Typically, instead of determining a status or a certain characteristic of a material at a given time, the goal of a material characterization system is to determine a set of properties of the material, such as those derived from a measurement of the transmissivity, reflectivity, and absorptivity of the material. This set of properties includes surface resistivity, ohmic conductivity, dissipation loss, complex magnetic permeability, and complex dielectric permittivity, in addition to thickness, density, homogeneity, and manufacturing defects, such as the presence of voids or undesired particles either during or after production of the material.

Currently, there is no well-established method of deterministically calibrating a material characterization system accurately by measuring and recording a single set of calibration data. Usually, because the accuracy of the material characterization system critically depends on having a set up as identical as possible for both calibration and characterization measurements, it is required that the sample under test and a reference material have the same thickness. In many cases, this might be difficult or impossible to achieve, particularly where the thickness of the sample under test is in the order of hundreds of microns. Also, preparing a reference layer identical to a sample layer might result in an inefficient and lengthy process. In addition, having a set of samples with a number of thicknesses to cover the range of possible samples to be characterized might be impractical or impose severe limitations to the material characterization system and its users.

As a result, users of a material characterization system typically experience inaccurate, lengthy, and inefficient calibration and characterization processes. On the one hand, different positioning or setups during the measurements of the reference material and the evaluation of the sample under test may largely compromise the accuracy of the characterization. Variations in position may be caused by a number of factors, including a lack of accurate control or not fine enough resolution of the positioning system, thickness variations of the measured materials, and fluttering and displacement of the material to be characterized.

On the other hand, the need to set up and measure a different reference material every time that a sample under test is changed or its thickness varies, involves a lengthier process and practical inconveniences that may severely impair the use of the material characterization system and build up to a highly inefficient characterization process. Each of these aspects is subject to uncertainties that make it difficult to create an accurate characterization of a material.

Previous efforts have been made to use electromagnetic waves in assisting with the calibration of a system to measure one or more properties of a material, as described in U.S. Pat. No. 6,754,543 to Wold and U.S. Pat. App. No. 20020075006 by Goldfine et al. However, these efforts have faced certain challenges and limitations. In particular, attempts made to characterize thin layers of material where thickness variations in the order of tens of microns may affect a measurement. Likewise, in a production environment, quality control of the material may be limited to measurements of a few samples because the time involved in evaluating the material may make prohibitive measuring the whole production. A major challenge is that in a production line, fluttering and displacement of a thin film of a material from a baseline position is typically unavoidable. Therefore, a characterization of a material may, as a result, be impractical and very challenging.

Thus, there remains a need in the art for methods and apparatuses capable of providing the means to accurately and effectively calibrate a material characterization system, through measurements of electromagnetic waves, that avoid the problems of prior art methods and devices.

### SUMMARY OF THE INVENTION

An improved method and apparatus to set up measurements for collecting data to calibrate a material characterization system are disclosed herein. One or more aspects of exemplary embodiments provide advantages while avoiding disadvantages of the prior art. The method and apparatus are operative to set up multiple configurations for measuring and recording a specific characteristic response of the system for each configuration, using electromagnetic waves. The apparatus is designed to enable the system to measure and record the position of a reference material and a set of calibration data for such reference material, while positioned at locations that correspond to a range of possible thicknesses or fluttering during measurements of a sample that the system is capable of characterizing. As a result, a sample under test having a specific thickness and measured at a particular position can be readily calibrated analytically or by using reference data previously recorded with the same set up.

The method of setting up multiple configurations for data collection to calibrate a material characterization system, using electromagnetic waves, includes the steps of attaching a supporting structure to a material characterization system to be calibrated and measuring and recording the S11 and S22 scattering parameters corresponding to a first reference material at different positions. The method further includes the steps of replacing the first reference material with a second reference material and measuring and recording the S12 or S21 scattering parameter, while maintaining the same mechanical set up at such different positions. The method also includes removing the supporting structure, as required, from the material characterization system.

The apparatus includes one or more structures configured and positioned to accurately set up a reference material at a plurality of positions to be measured by a material characterization system. By recording the measured characteristic response of such known reference material at these known plurality of positions, it is possible to calibrate and compare the corresponding response of a material to be characterized, having the same set up.

Accordingly, the collection of a set of calibration data for each possible position, corresponding to the different thicknesses or fluttering during measurements of a sample of a material to be characterized, allows a single calibration of the material characterization system. The minimum difference in distance among any two of these positions defines the distance resolution of the calibration. The apparatus may include technology to enable a distance resolution in the order of 10 microns.

As a result, the apparatus increases the accuracy of the positions at which the calibration data is collected. In addition, there is no need to measure a set of calibration data every time a material characterization measurement is performed, as is typically done using standard techniques. This is particularly important where evaluation of multiple samples of a material are required or in a production line where a material characterization system is used to monitor the quality of a material under production.

Thus, by enabling the collection of calibration data only once, at accurate positions, with a low distance resolution, the method and apparatus are capable of significantly improving both the calibration and the overall material characterization processes, as compared to standard techniques.

### BRIEF DESCRIPTION OF THE DRAWINGS

The numerous advantages of the present invention may be better understood by those skilled in the art by reference to the accompanying drawings in which:

FIG. 1 shows a schematic view of a method for calibration of a material characterization system, based on the transmission of electromagnetic waves.

FIG. 2 shows an exemplary set up for data collection to enable a calibration of a material characterization system using a two-stacked-tray supporting structure.

FIG. 3 shows a preferred set up for data collection to enable a calibration of a material characterization system using a two-stacked-tray supporting structure.

FIG. 4 shows an alternative set up for data collection to enable a calibration of a material characterization system.

FIGS. 5A and 5B show various aspects of an apparatus using a two-stacked-tray structure in accordance with one embodiment.

FIG. 6 shows a perspective view of an apparatus using a two-stacked-tray structure in accordance with another embodiment.

### DETAILED DESCRIPTION OF THE INVENTION

The following description is of a method and one or more particular embodiments of an apparatus, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

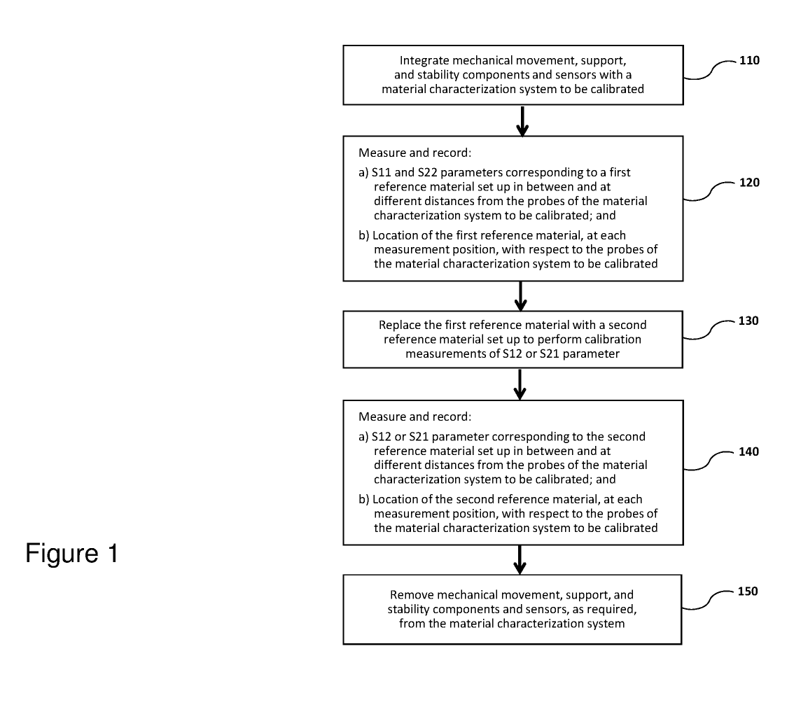

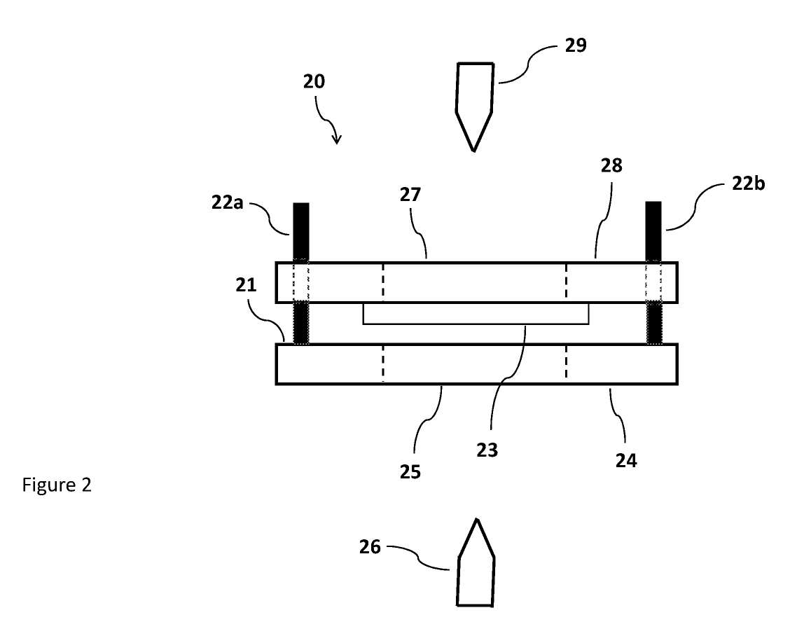

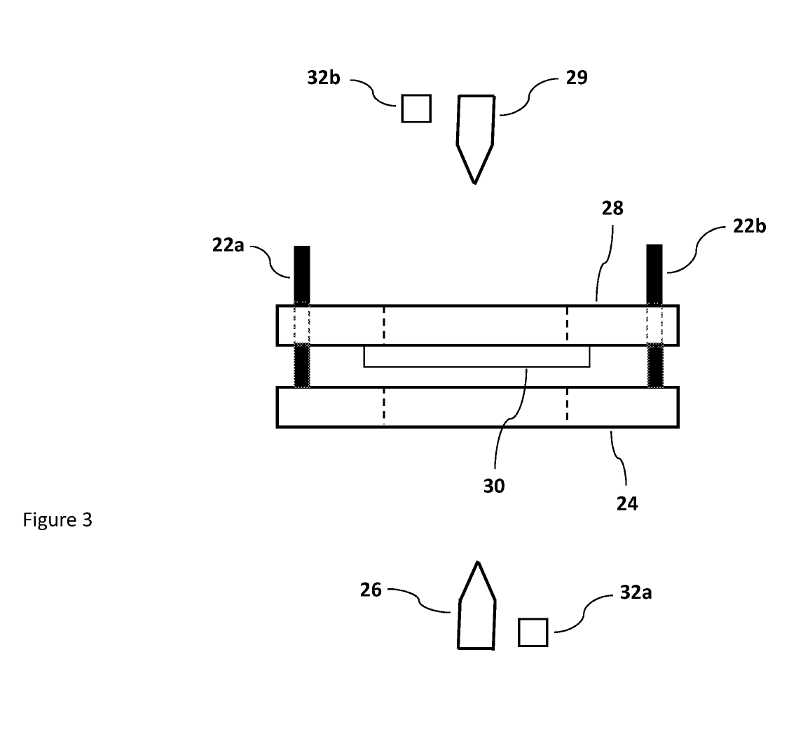

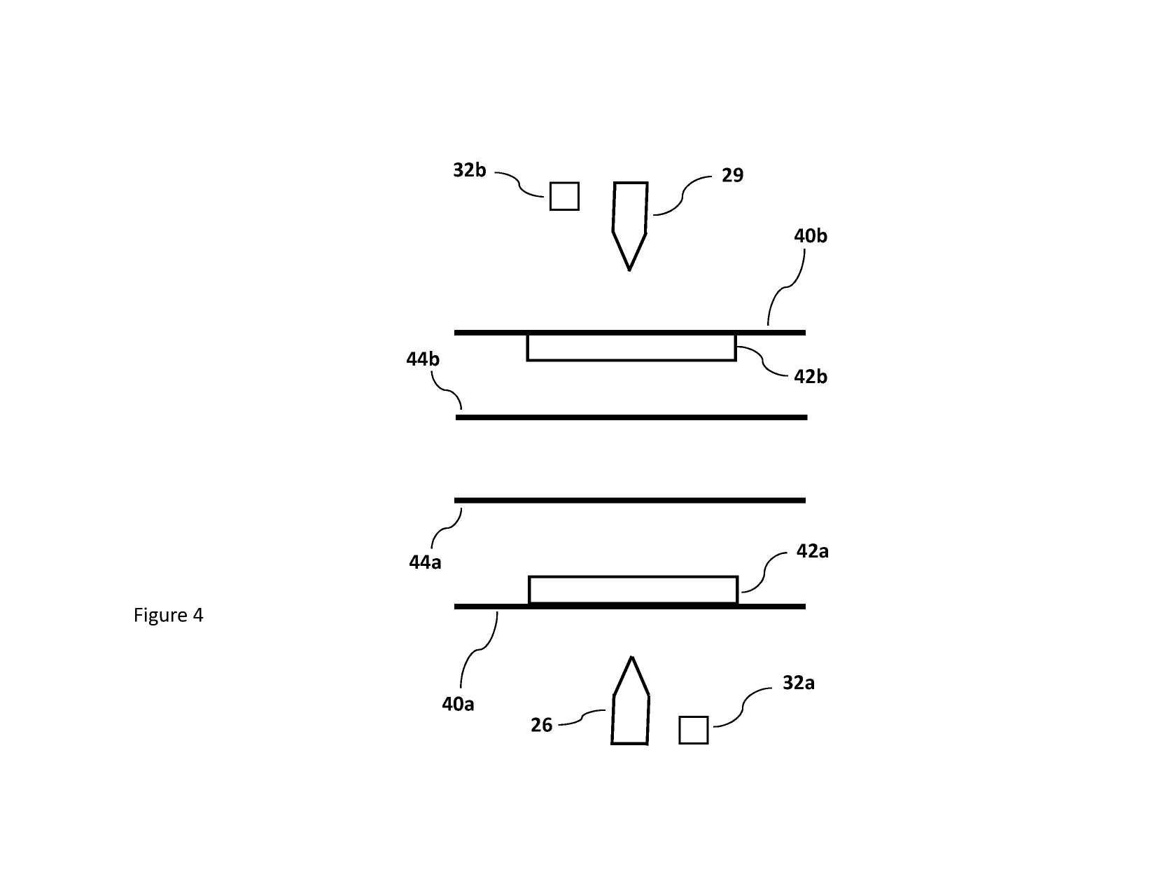

FIG. 1 shows a schematic view of a method for calibration of an electromagnetic wave-based material characterization system. The method is operative to determine a set of values of the measured scattering parameters of one or more reference materials, representative of a range of possible thicknesses of a sample layer of a material to be characterized, using the same set up, according to the following:
1. At step 110, attaching a supporting structure to a measuring module tray of a material characterization system to be calibrated, such that the structure is substantially parallel to such measuring module tray.
   FIG. 2 shows an exemplary set up, wherein a supporting structure 20 comprises two stacked trays. A first bottom tray 24, closer to a first probe 26 of the material characterization system, is disposed substantially parallel and in close proximity to a second top tray 28, closer to a second probe 29 of the material characterization system. Bottom tray 24 has a propagation area 25 around the center to allow the propagation of electromagnetic waves, transmitted by first probe 26 to second probe 29 through bottom tray 24.
   Likewise, top tray 28 has a propagation area 27 around the center, wherein a reference material 23 is disposed on to perform calibration measurements. The dimensions of such area of top tray 28 should be similar to the dimensions of the propagation area of bottom tray 24.
   Both top tray 28 and bottom tray 24 are preferably aligned such that propagation area 25 of bottom tray 24 coincides with propagation area 27 of top tray 28. More preferably, reference material 23 should be disposed as flat as possible, and in some instances, the top tray may comprise a thin layer of glass coated with the reference material to ensure flatness.
   Alternatively, supporting structure 20 may comprise a single tray, performing as top tray 28 in FIG. 2, in which case the measuring module tray of a material characterization system to be calibrated performs as bottom tray 24 in FIG. 2.
2. Next, at step 120, measuring and recording the amplitude and phase of the S11 and S22 parameters corresponding to a first reference material at different distances from the probes of the material characterization system.
   FIG. 3 shows a preferred set up, wherein a first reference material 30 is disposed on top tray 28. Top tray 28 is moved in steps from or to bottom tray 24, which remains fixed, to cover a range of movement that corresponds to the different thicknesses of the possible samples to be characterized by the material characterization system. Typically, the thickness of the sample to be characterized is within a range of between 50 microns and 40 mm at 10-micron steps.
   Characterizing a sample under test requires calibration with a reference material positioned at the same location as the sample, such that the probes are at the same distance from the sample and from the reference material during each of the corresponding set of measurements. However, depending on the thickness or fluttering during measurements of the sample under test, the distance from the sample to at least one of the probes of the material characterization system may vary.
   Therefore, a preferred set up includes one or more distance sensors 32a and 32b to measure the location of first reference material 30 with respect to bottom tray 24, probe 26, probe 29 or any other reference point at each calibration measurement position. This allows determining the location of first reference material 30, at each measurement position, with respect to probes 26 and 29 of the material characterization system to be calibrated.
   Ultimately, a matrix or table may be created containing the S11 and S22 calibration data and the position of the first reference material 30 with respect to probes 26 and 29 for each measurement of first reference material 30.
   Alternatively, step 120 may be performed by measuring and recording the amplitude and phase of the S11 and S22 parameters of one or more reference materials, one at a time, at least at two calibration reference planes located in between the probes. FIG. 4 shows a set up wherein a first calibration reference plane 40a is established to position reference material 42a for measurements and data recording. Likewise, a second calibration reference plane 40b is established to position reference material 42b for measurements and data recording. Typically, a sample of a material under test would be disposed such that a range of positions of such sample is limited within a first variation reference plane 44a and a second variation reference plane 44b. Calibration reference plane 42a is set up in between probe 26 and variation reference plane 44a. Similarly calibration reference plane 42b is set up in between probe 29 and variation reference plane 44b.
   Thus, by determining the location of a sample under test at each measurement position by means of distance sensors 32a or 32b, the distance between each calibration reference plane 40a and 40b and the sample can be calculated. As a result, the S11 and S22 parameters of reference materials 42a and 42b can be analytically calculated at the position of the sample, as well-known in the prior art. This calculation can be done for any position of the sample material to be characterized between calibration reference planes 40a and 40b.
   Preferably, reference materials 42a and 42b are identical. More preferably, reference materials 42a and 42b are actually the same piece of material used at different times. Most preferably, in addition, reference materials 42a and 42b comprise a material highly reflective of electromagnetic waves at the frequencies of interest, including a conductive material, such as a metal plate or a layer of a metal compound.
3. Next, at step 130, replacing the first reference material with a third reference material to have a set up to perform calibration measurements of the S12 or S21 parameters, while maintaining the same mechanical set up used in step 120. Preferably, the third reference material is air, such that replacing the first reference material basically reduces to removing the first reference material.
4. Next, at step 140, repeating step 120 for the corresponding calibration measurements of the S12 or S21 parameter. After completing step 140, the data required for calibration of material characterization system is complete.
   A set of the measured S11, S22, and S12 or S21 scattering parameters have been recorded for each possible height position corresponding to the different thicknesses or fluttering during measurements of the sample to be characterized by the material characterization system, within a 10-micron distance resolution or as determined in step 120.
   Preferably, the measurements of the S12 or S21 parameter are performed using air as the third reference material. In such a case, only a measurement of the S12 or S21 parameter at each height position may be required.
5. Last, at step 150, removing the supporting structure and movement or mechanical stability components, as required, from the measuring module tray of the calibrated material characterization system.

Once a sample layer of material under test is placed on the module tray of the calibrated material characterization system, the thickness and position of the sample can be measured using the measurement tool used during the calibration process. Therefore, the position of the sample will be within 10 microns, or as determined in step 120, of two positions of the recorded calibration data. Therefore, the S11, S22, and S12 or S21 measured data corresponding to these two positions can be used to accurately characterize the sample layer of the material under test.

Those skilled in the art will recognize that the steps above indicated can be correspondingly adjusted for specific material characterization system configurations. In particular, the steps to complete the calibration measurements of the S12 or S21 parameter can be performed before the calibration measurements of the S11 and S22 parameters. Likewise, the use, position, and function of the bottom or top trays of the two-stacked-tray structure may be altered or switched depending on the particular material characterization system to be calibrated. Also, those skilled in the art will realize that other type of reference materials may be used to perform S11, S22, and S12 or S21 measurements using the same reference material, including one or a combination of more than one of a transparent conductive material, a nanowire or a copper mesh, metamaterials, and nanomaterials.

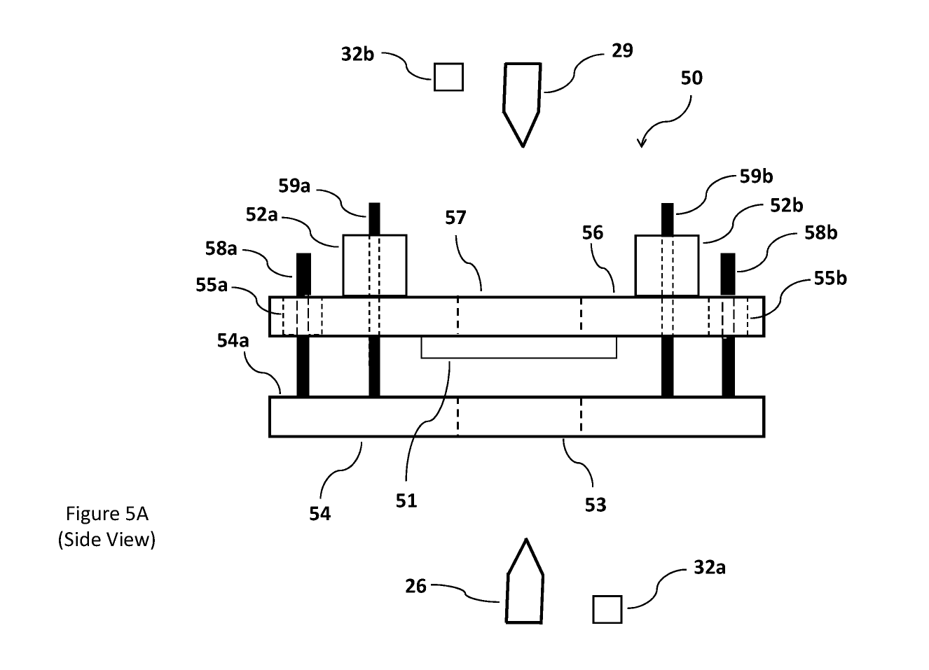

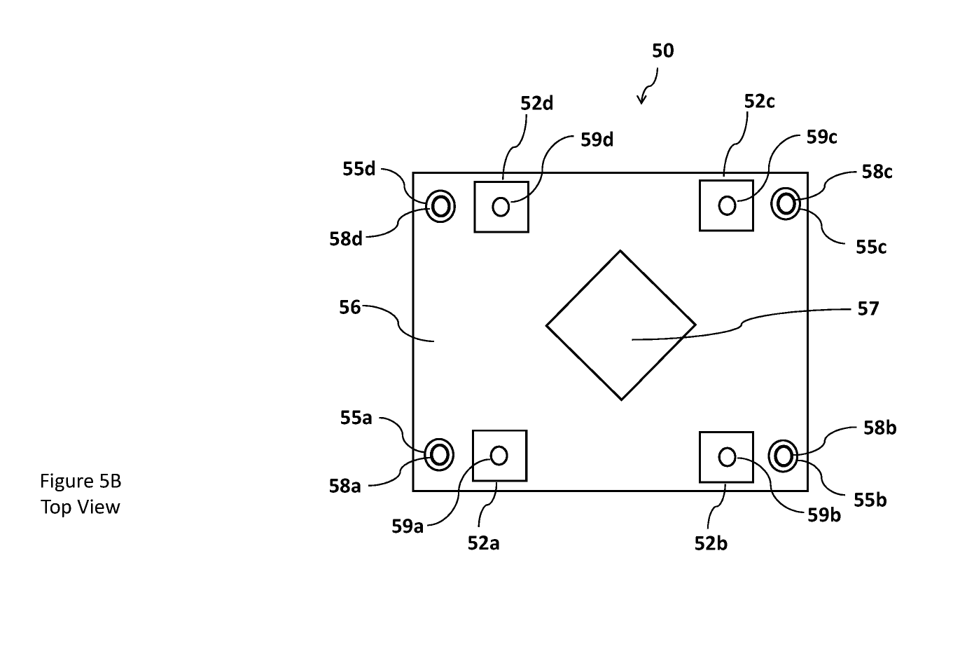

In accordance with certain aspects of an embodiment of the invention, FIGS. 5A and 5B show various aspects of an apparatus 50 that enables a calibration of a material characterization system. Apparatus 50 is configured to provide a plurality of measurement setups to collect a set of calibration data using one or more reference materials. Then these data may be used to calibrate a measurement for all the possible practical thicknesses or positions during measurements of a sample of a material to be characterized. In this configuration, each measurement setup is defined by a position controlled by four step motors 52a, 52b, 52c, and 52d, commercially available as well known to those skilled in the art.

In particular, FIG. 5A illustrates a side view of apparatus 50, comprising a first bottom tray 54, closer to a first probe 26 than to a second probe 29 of the material characterization system, and a second top tray 56, closer to second probe 29 than to first probe 26 of the material characterization system. Bottom tray 54 is disposed substantially parallel and in close proximity to top tray 56. Thus, bottom tray 54 and top tray 56 form a two-tray stacked structure. Preferably, bottom tray 54 and top tray 56 each has a rectangular shape with similar dimensions. In this embodiment bottom tray 54 and top tray 56 each has approximate dimensions of 300 mm in width and length and 5 mm in thickness.

Thus, in a preferred configuration, apparatus 50 comprises one or more distance sensors 32a and 32b to measure the location of a first reference material 51 with respect to bottom tray 54, probe 26, probe 29 or any other reference point at each calibration measurement position. Distance sensors 32a or 32b may include a laser sensor, an acoustic sensor, and a measurement tool either installed as part of or added-on to the material characterization system.

More specifically, FIG. 5B shows a top view of a configuration of apparatus 50, in which step motors 52a, 52b, 52c, and 52d are mechanically attached by means of screws to top tray 56. In addition, top tray 56 comprises a first opening 57 of about 50 mm in width and 50 mm in length located at around the center of top tray 56. Top tray 56 is positioned such that a second opening 53 of bottom tray 54, having the same dimensions as first opening 57, aligns with first opening 57 to allow the propagation of electromagnetic waves, between first probe 26 and second probe 29 through first and second openings 57 and 53. Preferably, the dimensions of first opening 57 and second opening 53 are selected such that the spot size of first probe 26 and the spot size of second probe 29, over the location of first opening 57 and second opening 53, define an area smaller than the area of first opening 57 and second opening 53. Most preferably, the spot size of first probe 26 and the spot size of second probe 29 each define an area no larger than 60% of the area defined by first opening 57 or second opening 53.

In reference to FIGS. 5A and 5B, four extension arms 58a, 58b, 58c, and 58d are mechanically attached by means of screws to bottom tray 54, such that extension arms 58a, 58b, 58c, and 58d protrude toward top tray 56 substantially perpendicular to bottom tray 54. Each extension arm 58a, 58b, 58c, and 58d consists of a general purpose, circular cross-section steel rod of approximately 5 mm in diameter and about 50-mm long, positioned close to each corner of bottom tray 54.

Additionally, each extension arm 58a, 58b, 58c, and 58d inserts into a corresponding circular through-hole 55a, 55b, 55c, and 55d on top tray 56. Preferably, the diameter of each circular through-hole 55a, 55b, 55c, and 55d of top tray 56 is just large enough to allow top tray 56 to slide along extension arms 58a, 58b, 58c, and 58d, while maintaining mechanical stability during motion and during measurements at fixed positions. Those skilled in the art will recognize that other methods may be implemented for a stable mechanical guidance of top tray 56. For instance, a different number of extension arms, preferably two or more, may be used. Alternatively, a semicircular dent in two or more sides of top tray 56 may be used to fit an extension arm as described above.

In a preferred configuration, and in reference to FIGS. 5A and 5B, each step motor 52a, 52b, 52c, and 52d includes an actuator arm 59a, 59b, 59c, and 59d consisting of a fully threaded, circular cross-section steel rod of approximately 2 mm in diameter and about 100-mm long, positioned close to each corner of bottom tray 54. More preferably, each actuator arm 59a, 59b, 59c, and 59d is disposed substantially perpendicular to top tray 56 and extends to bottom tray 54 through a hole in top tray 56. Most preferably, each step motor 52a, 52b, 52c, and 52d is disposed on and mechanically attaches by means of two screws to top tray 56, adjacent to extension arms 58a, 58b, 58c, and 58d, and close to each corner and the perimeter of top tray 56.

Therefore, when step motors 52a, 52b, 52c, and 52d actuate, corresponding actuation arms 59a, 59b, 59c, and 59d may cause top tray 56 to move up or down, or equivalently away from or closer to bottom tray 54 at certain step increments. In other words, actuation arms 59a, 59b, 59c, and 59d use bottom tray 54 as an anchor to push up top tray 56 away from the bottom tray 54 from a position in which top tray 56 and bottom tray 54 are at the closest distance. Preferably, step motors 52a, 52b, 52c, and 52d move top tray 56 in increments as small as 10 microns. The step increment at which step motors 52a, 52b, 52c, and 52d move top tray 56 determines a calibration distance resolution of the material characterization system. This configuration of apparatus 50 allows measurement setups to obtain calibration data of a sample of a material having a thickness of at least between 50 microns and 40 mm.

In general, apparatus 50 mechanically attaches to a measuring module tray of the material characterization system to be calibrated, such that bottom tray 54 and top tray 56 are disposed substantially parallel to such measuring module tray. Accordingly, apparatus 50 may have one or more sensors to level bottom tray 54 and top tray 56 with respect to the measuring module tray. Moreover, apparatus 50 may be integrated with the material characterization system in a fixed or temporary configuration. Thus, apparatus 50 may be portable and used to calibrate the material characterization system only once or as needed. Alternatively, apparatus 50 may be attached to and become an integral part of the material characterization system.

Preferably, in an alternative configuration, apparatus 50 further comprises hardware, software, and firmware to enable apparatus 50 to perform automated, electronic calibration of a material characterization system as a self-contained E-Cal Tray Kit. In a preferred configuration as an E-Cal Tray Kit, apparatus 50 comprises a motor controller to drive step motors 52a, 52b, 52c, and 52d and is connected to a computer by means of a Universal Serial Bus (USB) connector. More preferably, an E-Cal Tray software installed in the computer may be used to perform automated measurements of the scattering parameters required for the calibration process.

The use of apparatus 50 as an E-Cal Tray Kit helps also to reduce inaccuracies of the characterization measurements by calibrating out any inconsistencies resulting from the manufacturing and assembly phases of the material characterization system. More specifically, an E-Cal Tray Kit may be programmed to automatically position top tray 56, by means of a motorized unit, and measure the scattering parameters of a reference material at every 10 microns over a range of up to 40 mm or in accordance with the specifications of the material characterization system to be calibrated. Most preferably, such reference material comprises a material highly reflective of electromagnetic waves at the frequencies of interest, including a conductive material, such as a metal plate or a layer of a metal compound.

Those skilled in the art will recognize other ways of integrating apparatus 50 with a material characterization system, including by means of a straight, L-shaped or U-shaped arm; a flange; fasteners; hooks; clamps; adhesive, and straps, depending on the temporary or permanent nature of the attachment. Preferably, the integration of apparatus 50 incorporates existing trays to compensate for manufacturing and material inconsistencies of the material characterization system. Accordingly, in an alternative configuration, apparatus 50 may not require two trays. However, replacement of a component of the material characterization to install apparatus 50 may be advisable in certain situations.

A preferred mechanism to attach apparatus 50 to a material characterization system includes a manner to have an adjustable set up, including by means of a gear mechanism, calibrated screws, and knobs. More preferably, the attachment mechanism is also reconfigurable to adapt to different settings of spacing and positioning of a material. Those skilled in the art will also realize that other operational modes of using apparatus 50 may be implemented, such as manual or semi-automated. In particular, the movement of apparatus 50 to set up a position may be controlled by a hand-operated dial system.

Those skilled in the art will also realize that in certain instances a sample of a material having an edge treatment, such as a radio frequency absorber material, may need to be measured. In these instances, the absorber material may be configured to easily integrate into the material characterization system. Alternatively, apparatus 50 may comprise an absorber material, configured as a mold and cast into top tray 56, wherein a sample of a material to be measured fits. Thus, casting the absorber material allows to more easily obtain a desired shape, such as a wedge, as compared to casting the reference material.

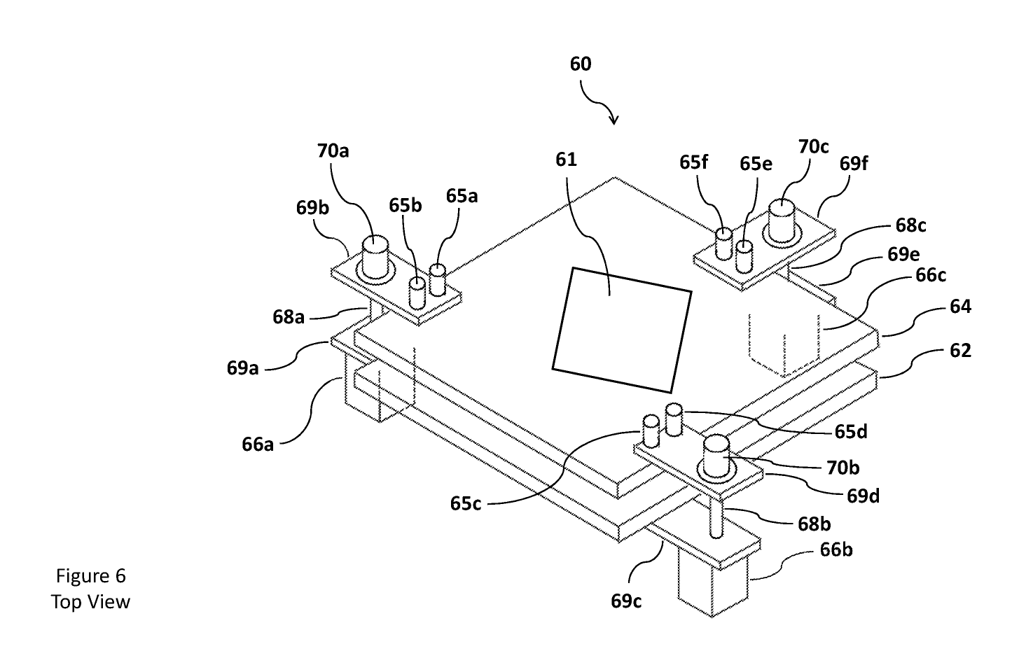

In accordance with another embodiment, FIG. 6 shows a perspective view of an apparatus 60, comprising a two-stacked-tray structure consisting of bottom tray 62, having a first propagation area (not shown), and top tray 64, having a second propagation area 61. Apparatus 60 further comprises three step motors 66a, 66b, and 66c, commercially available as well known to those skilled in the art. Each step motor 66a, 66b, and 66c includes a linear actuator 68a, 68b, and 68c and attaches to two mounting plates, a bottom mounting plate 69a, 69c, and 69e and a top mounting plate 69b, 69d, and 69f. In addition, an external linear nut (ELN) 70a, 70b, and 70c attaches to each mounting plate 69a, 69b, 69c, 69d, 69e, and 69f, such that linear actuators 68a, 68b, and 68c are mechanically attached to ELN 70a, 70b, and 70c.

Preferably, each top mounting plate 69b, 69d, and 69f attaches to top tray 64 by means of two thumb screws 65a and 65b, 65c and 65d, and 65e and 65f. Likewise, each bottom mounting plate 69a, 69c, and 69e attaches to bottom tray 62 by means of two thumb screws (not shown). In this configuration, the thumb screws are preferred for easy mounting and dismounting of mounting plates 69a, 69b, 69c, 69d, 69e, and 69f to and from bottom tray 62 and top tray 64. However, those skilled in the art will recognize other means of attaching mounting plates 69a, 69b, 69c, 69d, 69e, and 69f to bottom tray 62 and top tray 64.

More preferably, mounting plates 69a, 69b, 69c, 69d, 69e, and 69f are attached to bottom tray 62 and top tray 64, such that step motors 66a, 66b, and 66c are disposed equidistant one another around the perimeters of bottom tray 62 and top tray 64, forming an equilateral triangle. Most preferably, step motors 66a, 66b, and 66c are wired in series or daisy-chained together to a motor driver and controller connected to a computer via a USB cable, as well known in the prior art. Most preferably, an E-Cal Tray software is installed in the computer and may be used to perform automated measurements at different setups during the calibration process.

The method and various embodiments of the apparatus for setting up the data collection configurations to perform the calibration of a material characterization system have been described herein in an illustrative manner, and it is to be understood that the terminology used is intended to be in the nature of words of description rather than of limitation. Any embodiment herein disclosed may include one or more aspects of the other embodiments. The exemplary embodiments were described to explain some of the principles of the present invention so that others skilled in the art may practice the invention. Obviously, many modifications and variations of the invention are possible in light of the above teachings. The present invention may be practiced otherwise than as specifically described within the scope of the appended claims and their legal equivalents.

We claim:

1. A method for setting up a configuration to measure a set of data pertaining to an electromagnetic wave to enable a calibration of a material characterization system comprising:
a. providing a supporting structure to hold a first reference material disposed in between a first antenna of said material characterization system and a second antenna of said material characterization system, wherein said first antenna and said second antenna are configured to transmit and receive said electromagnetic wave, wherein said first reference material is configured to reflect at least a first portion of said electromagnetic wave, wherein said supporting structure and said first reference material are set up as to enable said first portion of said electromagnetic wave to be detected by said first antenna as a result of said electromagnetic wave being transmitted by said first antenna and impinging upon said first reference material, and wherein said first reference material is set up as to enable said first portion of said electromagnetic wave to be detected by said second antenna as a result of said electromagnetic wave being transmitted by said second antenna and impinging upon said first reference material;
b. measuring and recording a first part of said set of data pertaining to said detected first portion of said electromagnetic wave at a first group of one or more distances from said first reference material to said first antenna and to said second antenna of said material characterization system;
c. replacing said first reference material with a second reference material, wherein said second reference material is capable of allowing a transmission of at least a second portion of said electromagnetic wave through said second reference material; and
d. measuring and recording a second part of said set of data pertaining to said second portion of said electromagnetic wave at each one of said first group of one or more distances from said second reference material to said first antenna and to said second antenna of said material characterization system.

2. The method of claim 1, wherein said supporting structure comprises a plurality of elements.

3. The method of claim 2, further comprising:
e. removing at least one of said plurality of elements of said supporting structure.

4. The method of claim 1, wherein said supporting structure and said second reference material are set up as to enable said second portion of said electromagnetic wave to be detected by said first antenna, as a result of said electromagnetic wave being transmitted by said second antenna, and wherein said supporting structure and said second reference material are set up as to enable said second portion of said electromagnetic wave to be detected by said second antenna, as a result of said electromagnetic wave being transmitted by said first antenna.

5. The method of claim 1, wherein said second reference materials is air.

6. The method of claim 1, wherein said set of data pertaining to said electromagnetic wave is used to calibrate a measured set of data collected by means of said material characterization system.

7. The method of claim 1, wherein said calibration corresponds to a measured set of data of a substantially planar sample of a material having a thickness of between 50 microns and 40 mm.

8. The method of claim 7, wherein said first reference material and said second reference material are substantially planar and positioned substantially parallel to a corresponding position of said planar sample of said material during a collection of data by means of said material characterization system.

9. The method of claim 1, wherein said first reference material is capable of substantially reflecting said electromagnetic wave.

10. The method of claim 1, wherein said electromagnetic wave is capable of substantially propagating through said second reference material.

11. The method of claim 1, wherein said first group of one or more distances consists of a plurality of distances differing from one another by a range of between 10 microns and a distance between said first antenna and said second antenna of said material characterization system.

12. The method of claim 1, wherein said first group of one or more distances consists of a plurality of distances from said first reference material to said first antenna and to said second antenna of said material characterization system, defining a range of distances in between said first antenna and said seconds antenna, and wherein said range of distances includes a plurality of possible positions of at least one material to be measured by said material characterization system.

13. The method of claim 12, wherein a cause of said plurality of possible positions of said material to be measured by said material characterization system is selected from the group consisting of a variation in thickness and fluttering during measurements of said material to be measured.

14. The method of claim 1, wherein said first reference material is capable of substantially reflecting said electromagnetic wave.

15. The method of claim 1, further comprising:
e. measuring and recording a third part of said set of data pertaining to said detected first portion of said electromagnetic wave at a second group of one or more distances from a third reference material to said first antenna and to said second antenna of said material characterization system.

16. The method of claim 15, wherein said first reference material and said third reference material have properties that at least similarly reflect said electromagnetic wave upon impingement of said electromagnetic wave on said first reference material and on said third reference material.

17. The method of claim 15, wherein said set of data pertaining to said electromagnetic wave to enable said calibration of said material characterization system comprises a scattering parameter.

18. The method of claim 15, wherein at least one distance from said first group of one or more distances establishes a first calibration reference plane in between said first antenna and said second antenna, wherein at least one distance from said second group of one or more distances establishes a second calibration reference plane in between said first antenna and said second antenna;
wherein said first antenna is closer to said first calibration reference plane than to said second calibration reference plane and said second antenna is closer to said second calibration reference plane than to said first calibration reference plane;
wherein a first position and a second position define a maximum distance amid a plurality of possible positions of at least one material to be measured by said material characterization system;
wherein said first position establishes a first variation reference plane and said second position establishes a second variation reference plane, such that said plurality of possible positions of said material to be measured are in between said first variation reference plane and said second variation reference plane;
wherein said first antenna is closer to said first variation reference plane than to said second variation reference plane and said second antenna is closer to said second variation reference plane than to said first variation reference plane;
wherein said first calibration reference plane is set up in between said first antenna and said first variation reference plane and said second calibration reference plane is set up in between said second antenna and said second variation reference plane;
and wherein said set of data pertaining to said electromagnetic wave to enable said calibration of said material characterization system can be analytically calculated at one or more of said plurality of possible positions of said material to be measured.

19. The method of claim 18, wherein said first variation reference plane, said second variation reference plane, said first calibration reference plane, and said second calibration reference plane are substantially parallel to one another.

20. The method of claim 18, wherein said set of data pertaining to said electromagnetic wave to enable said calibration of said material characterization system is analytically calculated based upon a distance between said material and said first and said second calibration reference planes.

21. An apparatus for setting up a configuration to measure a set of data pertaining to an electromagnetic wave to enable a calibration of a material characterization system, comprising:
a. a supporting structure configured to hold a first reference material disposed in between a first antenna of said material characterization system and a second antenna of said material characterization system, wherein said first antenna and said second antenna are configured to transmit and receive said electromagnetic wave, wherein said first reference material is configured to reflect at least a first portion of said electromagnetic wave, wherein said supporting structure and said first reference material are set up as to enable said first portion of said electromagnetic wave to be detected by said first antenna as a result of said electromagnetic wave being transmitted by said first antenna and impinging upon said first reference material, and wherein said first reference material is set up as to enable said first portion of said electromagnetic wave to be detected by said second antenna as a result of said electromagnetic wave being transmitted by said second antenna and impinging upon said first reference material;
b. a mechanism to provide mechanical stability to said supporting structure during a measurement of said set of data; and
c. a means to set up said supporting structure at a plurality of positions.

22. The apparatus of claim 21, wherein said supporting structure comprises at least one tray, wherein said first reference material is disposed to measure at least a part of said set of data.

23. The apparatus of claim 22, wherein said supporting structure comprises a two-tray stacked configuration and at least one tray of said two-tray structure is movable.

24. The apparatus of claim 21, wherein said supporting structure is configured to allow a sample of a material to be measured to be disposed flat on said supporting structure.

25. The apparatus of claim 21, wherein said plurality of positions covers a range of distances larger than a range of thicknesses of a material to be characterized by said material characterization system and larger than a range of variations during measurements with respect to an initial setup of said material.

26. The apparatus of claim 25, wherein said plurality of positions covers a range of distances of at least between 10 microns and 40 mm.

27. The apparatus of claim 21, further comprising a means to measure said plurality of positions with respect to an element of said supporting structure.

28. The apparatus of claim 21, further comprising a means to measure said plurality of positions with respect to an element of said material characterization system.

29. The apparatus of claim 21, wherein said means to set up said supporting structure at said plurality of positions comprises at least one motor to control the position of a material disposed on said supporting structure.

30. The apparatus of claim 21, wherein said supporting structure is mechanically attached to said material characterization system.

31. The apparatus of claim 21, wherein said mechanism to provide mechanical stability comprises at least one sensor to level said supporting structure.

32. The apparatus of claim 21, wherein said supporting structure comprises at least one propagation area to allow said electromagnetic wave to propagate through said propagation area.

33. The apparatus of claim 21, further comprising:
a set of hardware components, wherein at least one of said components is connected to said means to set up said supporting structure at said plurality of positions; and
a software installed in at least part of said hardware, wherein said hardware and said software are configured to automatically position said supporting structure at said plurality of positions and to perform an automated collection and a recording of said set of data.

34. The apparatus of claim 21, wherein said supporting structure comprises an absorbing element configured to absorb said electromagnetic wave, wherein said first reference material is set up integrated with said absorbing element.

35. The apparatus of claim 21, wherein said electromagnetic wave propagates in a frequency range of between 0.1 and 70 GHz.

36. The apparatus of claim 20, wherein said first electromagnetic wave propagates in a frequency range of between 6 and 30 GHz.
